(19) United States
(12) Patent Application Publication
(10) Pub. No.: US 2026/0278879 A1
(43) Pub. Date: Sep. 17, 2026

(54) IMAGE EDITING USING DELTA DENOISING SCORES

(71) Applicant: Google LLC, Mountain View, CA (US)

(72) Inventors: Kfir Aberman, San Mateo, CA (US); Amir Hertz, New York, NY (US); Daniel Cohen-Or, Hod Hasharon (IL)

(21) Appl. No.: 19/471,065

(22) PCT Filed: Apr. 1, 2024
(86) PCT No.: PCT/US2024/022507

§ 371 Date: Sep. 30, 2025

Related U.S. Application Data
(60) Provisional application No. 63/455,967, filed on Mar. 30, 2023.

(51) Int. Cl. G06T 11/60; G06T 5/60; G06T 5/70

(52) U.S. Cl. CPC G06T 11/60; G06T 5/60; G06T 5/70; G06T 2207/20081; G06T 2207/20084

(57) ABSTRACT

Methods, systems, and apparatus, including computer programs encoded on computer storage media, for editing images using delta denoising scores.

### CROSS-REFERENCE TO RELATED APPLICATIONS

This application claims priority to U.S. Provisional Application No. 63/455,967, filed on Mar. 30, 2023. The Disclosure of the Prior Application is Considered Part of and is incorporated by reference in the disclosure of this application.

### BACKGROUND

This specification relates to generating images using neural networks.

Neural networks are machine learning models that employ one or more layers of nonlinear units to predict an output for a received input. Some neural networks include one or more hidden layers in addition to an output layer. The output of each hidden layer is used as input to or more other layers in the network. i.e., one or more other hidden layers, the output layer, or both. Each layer of the network generates an output from a received input in accordance with current values of a respective set of parameters.

### SUMMARY

This specification describes a system implemented as computer programs on one or more computers that performs image editing using delta denoising scores.

In particular, in some examples, the system uses delta denoising scores generated using a trained diffusion neural network to directly optimize an initial image in order to apply, to the initial image, an edit that is specified by a received text description. In other words, the system generates a target image by editing, using delta denoising scores, an initial image as described in the text description.

In some other examples, the system uses the delta denoising scores and the trained diffusion neural network to train an image-to-image translation neural network through unsupervised learning.

Once trained, the system or another system can use the image-to-image translation neural network to edit the input image, i.e., to generate output images that are edited versions of input images to the image-to-image translation neural network.

Particular embodiments of the subject matter described in this specification can be implemented so as to realize one or more of the following advantages.

Large-scale language-vision models have recently been used to generate and edit images. As one example, text-to-image generative models utilize textual input to condition the generation of images. A promising avenue in this field is Score Distillation Sampling (SDS)—a sampling mechanism that utilizes probability density distillation to optimize a parametric image generator using a 2D diffusion model as a prior (see, for example, “Dreamfusion: Text-to-3d using 2d diffusion”, B. Poole et al., arXiv:2209.14988, 2022, the contents of which are incorporated herein by reference, in particular section 2.1).

The effectiveness of the SDS stems from the rich generative prior of the diffusion model it samples from. This is in contrast to the direct use of a language-vision model, e.g., one which have been trained using contrastive loss, as a generative model. The prior of large generative diffusion models is particularly rich and expressive and has been demonstrated to be highly effective in generating high quality visual outputs across various domains, including images and 3D models, among others.

Despite its usefulness, one of the primary issues associated with SDS is its tendency to converge towards specific modes, which often leads to the production of blurry output that only capture the elements explicitly described in the input text prompt.

In particular, using SDS to edit an existing image by initializing the optimization procedure from that image may result in significant blurring of the image beyond the edited elements.

To address these issues, this specification describes a new diffusion-based scoring technique for optimizing a parametric model, e.g., a trained diffusion neural network, for the task of image editing.

Unlike SDS, which queries the generative model with a pair of image and text, the described techniques utilize an additional query of a reference image-text pair, where the text matches the content of the image. Then, the output score is the difference, or delta, between the results of the two queries. This scoring technique is referred to in this specification as the Delta Denoising Score (DDS).

In some examples, this specification describes how DDS is applied on two pairs of images and texts, where one is a reference image-text pair that remains intact during the optimization, and the other pair includes a target image that is optimized, starting from the reference image, to match a target text prompt in the pair. The delta scoring provides effective gradients, which modify the edited portions of the image, while leaving the others unchanged. This results in a high quality edited image that is true to both the source, reference image and the edit specified by the text prompt. In particular, by making use of DDS, the source image and its text description can be used for estimating undesirable and noisy gradients directions introduced by SDS and removing these from the final score that is used to update the target image. Therefore, if the task requires altering only a portion of the image using a new text description, the system can use the reference estimation and get a cleaner gradient direction to update the image.

Thus, DDS can be used as a prompt-to-prompt editing technique that can modify images by only editing their captions, where no mask is provided or computed.

This specification also describes how to use Delta Denoising Score to train a distilled image-to-image translation neural network without the need of paired training dataset, yielding a zero-shot image translation technique.

In particular, training the image-to-image translation neural network using DDS as described in this specification requires only a dataset of the source distribution, associated with simple captions that describe the source and target image distributions, and does not require any datasets of the target distribution.

In particular, such zero-shot training can be applied on a single or multi-task image translation neural network, and the source distribution can include synthetically generated and real images. Thus, the described training techniques can be used to train any of a variety of image translation neural networks to perform any of a variety of image editing tasks.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example neural network system.

FIG. 2A is a flow diagram of an example process for editing an input image using delta denoising scores to generate a target image.

FIG. 2B shows an example of computing a delta denoising score (DDS).

FIG. 2C shows an example of editing an image using DDS relative to editing the same image using SDS.

FIG. 3 is a flow diagram of an example process for training an image-to-image translation neural network using delta denoising scores.

FIG. 4 is a flow diagram of an example process for performing a training iteration during the training of an image-to-image translation neural network.

FIG. 5 shows an example of training an image-to-image translation neural network.

Like reference numbers and designations in the various drawings indicate like elements.

### DETAILED DESCRIPTION

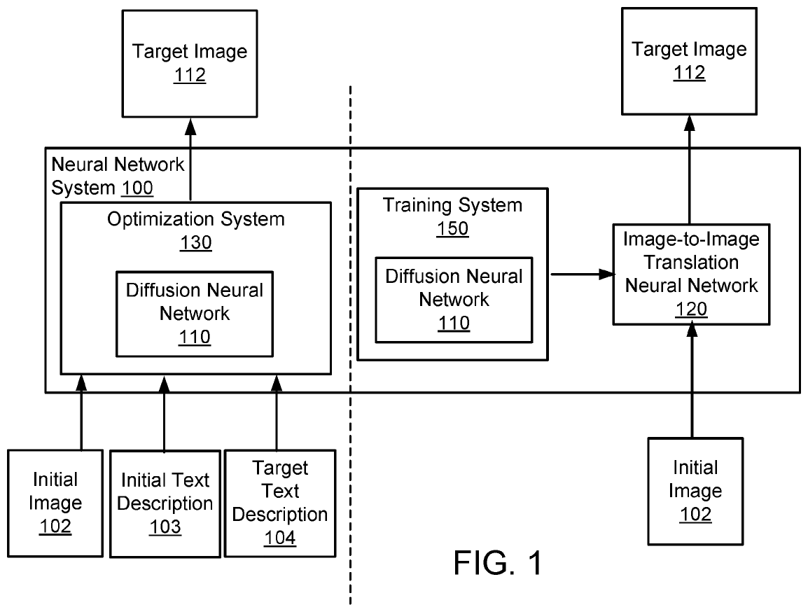

FIG. 1 is a diagram of an example neural network system 100. The neural network system 100 is an example of a system implemented as computer programs on one or more computers in one or more locations, in which the systems, components, and techniques described below can be implemented.

The system 100 is a system that performs image editing using delta denoising scores.

In particular, in some examples and as shown on the left-hand side of FIG. 1, the system 100 uses the delta denoising scores and a trained diffusion neural network 110 to directly optimize an initial image 102 in order to apply an edit to the initial image that is specified by a received text description 104.

In other words, an optimization system 130 within the system 100 generates a target image 112 by editing an initial image 102 across multiple updating iterations using delta denoising scores computed using the trained diffusion neural network 110, a description 103 of the initial image 102, and the text description 104 of the target image 112.

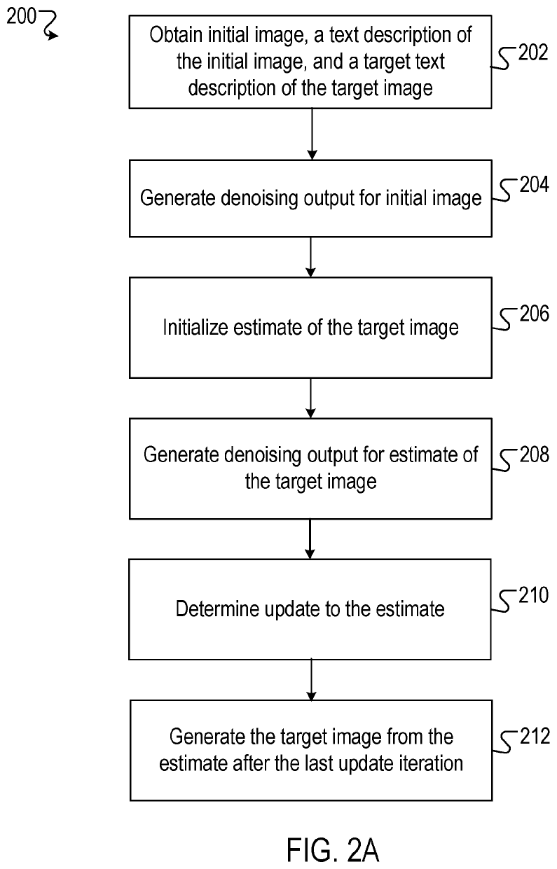

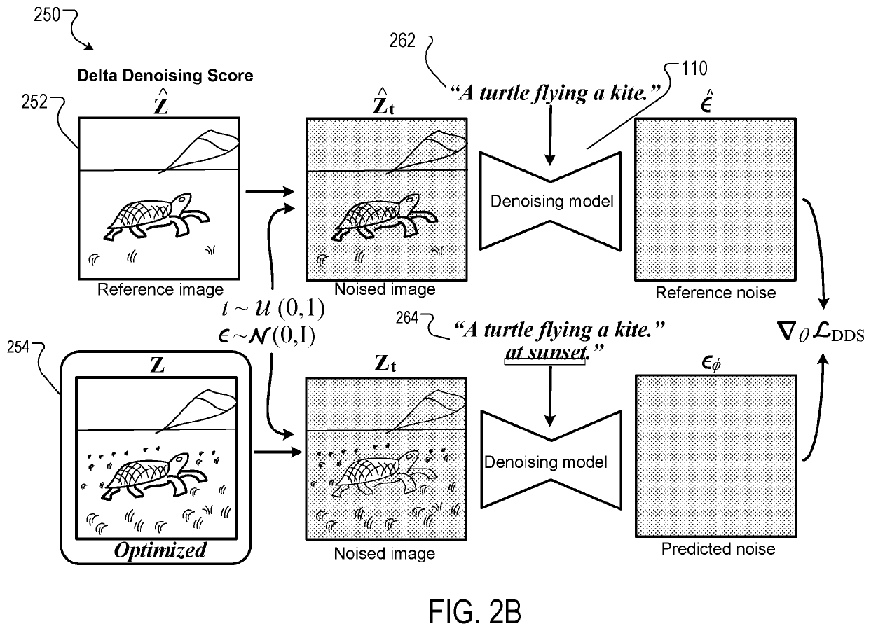

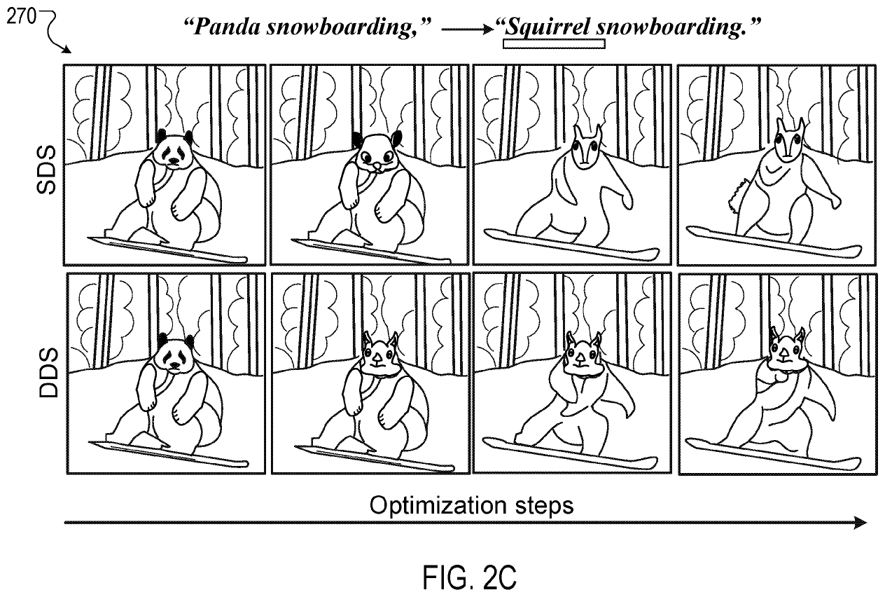

Using delta denoising scores to edit an initial image is described below with reference to FIGS. 2A-2C.

In some other examples, shown on the right-hand side of FIG. 1, a training engine 150 within the system 100 uses delta denoising scores generated using the trained diffusion neural network 110 to train an image-to-image translation neural network 120 through unsupervised learning.

The image-to-image translation neural network 120 is configured to receive a network input that includes an input image, i.e., the initial image 102, and to process the network input to generate an output image, i.e., the target image 112.

In some implementations, the image-to-image translation neural network 120 is a single task neural network that performs a single image editing task.

In some other implementations, the image-to-image translation neural network 120 is a multi-task neural network that can perform multiple different image editing tasks.

When the image-to-image translation neural network 120 is a multi-task neural network, the network input also includes data characterizing the corresponding image editing task to be performed on the input image to generate the output image. For example, the data characterizing the corresponding image editing task can be an embedding of the image editing task that is learned during the training of the image-to-image translation neural network 120.

Once trained, the system 100 or another system can use the image-to-image translation neural network 120 to edit an initial image 102, i.e., to generate, by processing the initial image 102, a target image 112 that is an edited version of the initial image 102 that has been edited by performing a corresponding image editing task on the initial image 102.

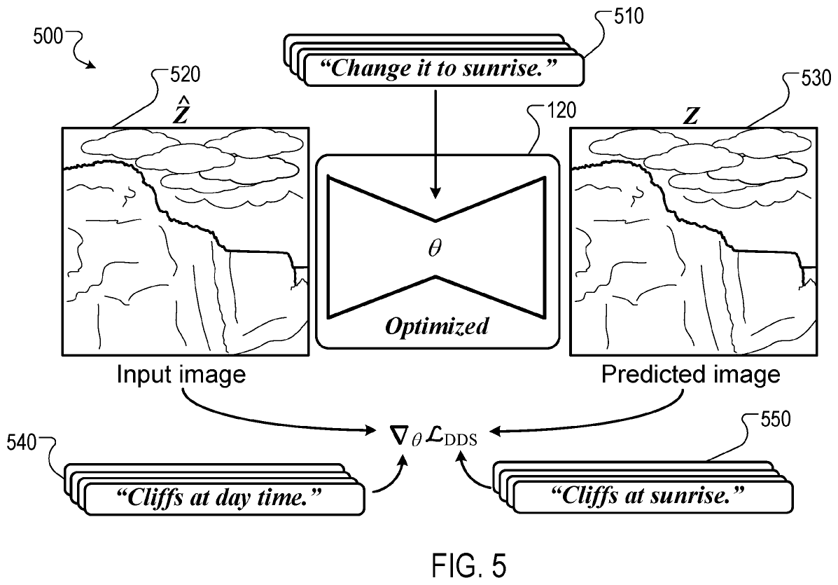

Training the image-to-image translation neural network is described below with reference to FIG. 5.

The trained diffusion neural network 110 can be any appropriate text-conditioned diffusion neural network.

In particular, the trained diffusion neural network 110 has been trained to receive a denoising input that includes an input image and a text description for a target image and to process the input to generate a denoising output for the initial image. Generally, the denoising input also includes a timestep that defines a noise level for the input image.

In some implementations, the trained diffusion neural network 110 performs a diffusion process in pixel space, so that the images operated on and generated by the diffusion neural network have values for each pixel that specify color values, e.g., RGB values or another color encoding scheme. In these examples, the denoising output is an estimate of the noise that has been added to the target image to arrive at the input image.

In some other implementations, the trained diffusion neural network 110 performs a diffusion process in latent space, e.g., in a latent space that is lower-dimensional than the pixel space. That is, the images operated on by the diffusion neural network 110 are latent images and the values for the pixels of the images are learned, latent values rather than color values. In these examples, the denoising output is an estimate of the noise that has been added to a latent representation of the target image in the latent space to arrive at the input latent representation in the latent space.

In these implementations, the trained diffusion neural network 110 can be associated with an image encoder to encode images into the latent space and a decoder neural network that receives an input that includes a latent representation of an image and decodes the latent representation to reconstruct the image. For example, the encoder and decoder can have been trained jointly on an image reconstruction objective, e.g., a VAE objective, a VQ-GAN objective, or a VQ-VAE objective.

The diffusion neural network 110 can generally have any appropriate neural network architecture.

For example, the diffusion neural network 110 can be a convolutional neural network, e.g., a U-Net, that has multiple convolutional laver blocks. In some of these cases, the diffusion neural network 110 can include one or more attention layer blocks interspersed among the convolutional layer blocks. As will be described below, some or all of the attention blocks can be conditioned on a representation of the text description.

As another example, the diffusion neural network 110 can be a Transformer neural network that processes the denoising input through a set of self-attention layers to generate the denoising output.

Similarly, in some implementations, the image-to-image translation neural network 120 operates in pixel space, so that the images operated on and generated by the image-to-image translation neural network 120 have values for each pixel that specify color values, e.g., RGB values or another color encoding scheme.

In some other implementations, the image-to-image translation neural network 120 operates on and generates images in latent space, i.e., so that the images are latent images and the values for the pixels of the images are learned, latent values rather than color values.

In these implementations, after training, to edit an image, the image encoder neural network can be used to encode images into the latent space and the decoder neural network can be used to decode latent images generated by the translation neural network 120 to reconstruct the final, edited target image.

The translation neural network 120 can generally have any appropriate neural network architecture that maps an input image to an output image that has the same dimensionality.

For example, the translation neural network 120 can be a convolutional neural network, e.g., a U-Net, that has multiple convolutional layer blocks.

As another example, the diffusion neural network 110 can be a Transformer neural network.

FIG. 2A is a flow diagram of an example process 200 for editing an input image using delta denoising scores to generate a target image. For convenience, the process 200 will be described as being performed by a system of one or more computers located in one or more locations. For example, a training system, e.g., the neural network system 100 depicted in FIG. 1, appropriately programmed in accordance with this specification, can perform the process 200.

The system obtains an initial image, a text description of the initial image, and a target text description of the target image (step 202). That is, the target text description describes a target image to be generated by performing an image editing task on the initial image.

When the diffusion neural network operates in latent space, the initial image can have been generated by processing an original initial image in pixel space using the image encoder neural network.

The system generates a denoising output for the initial image (step 204).

As part of generating the denoising output, the system processes a first diffusion input that includes the initial image and the text description for the initial image using the trained diffusion neural network to generate an initial denoising output for the initial image. As part of processing the first diffusion input, the system can generate a noisy image from the initial image, e.g., by applying sampled noise sampled from a noise distribution in accordance with the noise level for a sampled time step, and then process the noisy image, the text description, and, optionally, the sampled time step using the trained diffusion neural network to generate the initial denoising output.

An example of generating a noisy image is described below.

In some implementations, the denoising output is equal to the initial denoising output.

In some other implementations, the system uses classifier-free guidance to generate the denoising output.

In these implementations, the system processes a third diffusion input that includes the initial image and does not include the text description for the initial image using the trained diffusion neural network to generate an initial unconditioned denoising output for the initial image and then combines the initial denoising output for the initial image and the initial unconditioned denoising output for the initial image in accordance with a guidance weight to generate the denoising output. That is, the system computes a weighted sum of the initial denoising output for the initial image and the initial unconditioned denoising output for the initial image in accordance with the guidance weight.

In particular, when processing the third diffusion input, the system processes the noisy image generated from the initial image but not the text description to generate the initial unconditional denoising output.

The system initializes an estimate of the target image (step 206). For example, when the diffusion neural network operates in the pixel space, the system can initialize the estimate of the target image to be equal to the initial image. When the diffusion neural network operates in the latent space, the system can process the initial image using an image encoder neural network to encode the input image into the latent space.

The system then updates the estimate of the target image at each of a plurality of update iterations. In particular, at each update iteration, the system performs steps 208 and 210 to update the estimate.

The system generates a denoising output for the estimate of the target image (step 208).

As part of generating the denoising output, the system can process a second denoising input that includes the estimate of the target image and the target text description using the trained diffusion neural network to generate an initial denoising output for the target image.

As part of processing the second diffusion input, the system can generate a noisy image from the estimate of the target image, e.g., by applying the sampled noise sampled from the noise distribution in accordance with the noise level for the sampled time step, and then process the noisy image, the text description, and, optionally, the sampled time step using the trained diffusion neural network to generate the initial denoising output. That is, the system uses the same sampled noise and the same sampled time step for both the first and second denoising inputs.

An example of generating a noisy image is described below.

In some implementations, the denoising output is equal to the initial denoising output.

In some other implementations, the system uses classifier-free guidance to generate the denoising output. In these implementations, the system processes a fourth diffusion input that includes the estimate of the target image and does not include the text description for the target image using the trained diffusion neural network to generate an initial unconditioned denoising output for the estimate of the target image.

The system can then combine the initial denoising output for the estimate of the target image and the initial unconditioned denoising output for the estimate of the target image in accordance with a guidance weight for the update iteration to generate the denoising output. That is, the system computes a weighted sum of the initial denoising output for the estimate target image and the initial unconditioned denoising output for the estimate of the target image in accordance with the guidance weight.

In particular, when processing the fourth diffusion input, the system processes the noisy image generated from the estimate but not the text description to generate the initial unconditional denoising output.

The system determines an update to the estimate of the target image based on the denoising output for the estimate of the target image and the denoising output for the initial image (step 210).

In particular, the system determines the update to the estimate of the target image by computing a delta denoising score (DDS) and then determining the update based on the DDS.

In particular, to compute the DDS, the system can determine a difference between the denoising output for the estimate of the target image and the denoising output for the initial image. Thus, the DDS considers both the current denoising score for the current estimate of the target image that is being generated and a “reference” denoising score for the fixed, initial image.

To determine the update based on the DDS, the system can determine, from at least the DDS, an optimizer input to an optimizer and then apply the optimizer to the optimizer input to determine the update. For example, the optimizer can be stochastic gradient descent (SGD). Adam, or another appropriate optimizer. Depending on the optimizer, the optimizer input can include, e.g., only the DDS or the DDS combined with other values, e.g., a learning rate, one or more momentum values.

After performing the update iterations, the system generates the target image from the estimate of the target image after being updated at the last update iteration of the plurality of update iterations (step 212).

For example, when the diffusion neural network operates in the pixel space, the target image can be equal to the estimate of the target image after being updated at the last update iteration of the plurality of update iterations.

When the diffusion neural network operates in the latent space, the estimate of the target image is a representation in a latent space. In these cases, the system can process the estimate of the target image after being updated at a last update iteration of the plurality of update iterations using a decoder neural network to generate the target image.

Generally, any given diffusion input can include a timestep. During training of the diffusion neural network, the timestep defines a noise level that is used to generate the noisy image in the corresponding diffusion input. In these cases, the timestep is the same in each diffusion input that includes the initial image or the estimate of the target image generated from the initial image.

Thus, the system can perform the process 200 to directly edit the initial image using delta denoising scores if a text description of the source and target image are available.

FIG. 2B shows an example 250 of computing a delta denoising score (DDS).

As shown in the example 250, the system computes the delta denoising score using the trained diffusion neural network 110 (“denoising model”). More specifically, the example 250 represents the computation of the DDS given a reference image \hat{z} 252, i.e., the initial image, and an optimized image z 254, i.e., the current estimate of the target image. In the example 250, the DDS is computed using the same timestep t and the same noise ϵ, with both being sampled from a respective distribution.

In the example of FIG. 2B, the reference image 252 is associated with a reference text description 262 (“A turtle flying a kite”) and the target image 254 is associated with a target text description 264 (“A turtle flying a kite at sunset”).

To compute the DDS in the formulation of FIG. 2, the system generates respective noised (“noisy”) images zₜ and \hat{z}ₜ from the reference and optimized images and then processes a respective denoising input generated from each of the noised images using the trained diffusion neural network

$${ϵ}_{ϕ}^{ω}$$

and computes respective denoising outputs by applying classifier free guidance in accordance with a guidance weight ω as described above.

To generate a noisy (or noised image) zₜ from an optimized image z given timestep t and noise ϵ, the system can perform the following:
zₜ=\sqrt{α̅ₜ}z+\sqrt{1−α̅ₜ}∈, where α̅ₜ is a noise level that depends on the sampled time step t. In particular, the noise level is a decreasing function of the sampled time step t, so that the larger t is the noisier zₜ will be.

In some implementations, the DDS can be represented symbolically as:

$${∇}_{θ} {ℒ}_{DDS} = ( {ϵ}_{ϕ}^{ω} ( {z}_{t} , y , t ) - {ϵ}_{ϕ}^{ω} ( {\hat{z}}_{t} , \hat{y} , t ) ) \frac{\partial z}{\partial θ}$$

Where y is the target text description 264, ŷ is the reference text description 262, and θ are parameters of an image generation model. In some examples, i.e., the examples described above, the parameters of the image generation model may be the pixel values themselves. In general, the parameters may be parameters of arbitrary differentiable parametric function that renders images.

The DDS can alternatively be represented as a difference between two SDS scores, e.g.:

$${∇}_{θ} {ℒ}_{DDS} = {∇}_{θ} {ℒ}_{SDS} ( z , y ) - {∇}_{θ} {ℒ}_{SDS} ( \hat{z} , \hat{y} )$$

By making use of the DDS, the DDS pushes the optimized image into the direction of the target text prompt without the interference of the noise component. In particular, by subtracting the SDS score for the reference image from the SDS score for the optimized image, the system removes the interference of the noise component on the update that will be applied to the optimized image to push the optimized image into the direction of the target text prompt.

FIG. 2C shows an example 270 of editing an image using DDS relative to editing the same image using SDS.

As can be seen from the example 270, editing the image using DDS results in an edit that is significantly higher-quality and less-blurry than editing the image using SDS.

As described above, instead of directly using DDS to edit an input image, the system can train, using DDS, an image-to-image translation neural network that can then be used to perform an image editing task.

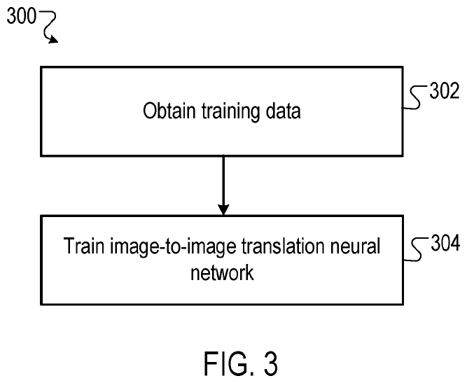

FIG. 3 is a flow diagram of an example process 300 for training an image-to-image translation neural network using delta denoising scores. For convenience, the process 300 will be described as being performed by a system of one or more computers located in one or more locations. For example, a training system, e.g., the neural network system 100 depicted in FIG. 1, appropriately programmed in accordance with this specification, can perform the process 300.

The system obtains training data for training the translation neural network (step 302).

The training data includes a set of training examples, with each training example corresponding to a respective image editing task from a set of one or more image editing tasks. Each training example includes a respective initial image, a respective text description of the respective initial image, and a respective target text description for the initial image that describes a target image that is generated by performing the corresponding image editing task on the respective initial image.

The system trains the image-to-image translation neural network on the training data. As described above, the image-to-image translation neural network is configured to receive a network input that includes an input image and to process the network input to generate an output image.

When the image-to-image translation neural network is a multi-task neural network, i.e., the set of image editing tasks includes multiple tasks, the network input also includes data characterizing the corresponding image editing task to be performed on the input image to generate the output image. For example, the data characterizing the corresponding image editing task can be an embedding of the image editing task that is learned during the training of the image-to-image translation neural network.

In particular, the system can train the translation neural network across a sequence of training iterations so that the translation neural network can effectively perform the one or more image editing tasks on input images after training.

At each training iteration, the system updates the network parameters of the translation neural network using delta denoising scores computed using the trained diffusion neural network.

Advantageously, because the training examples only include a respective target text description that describes a target image, but do not need to include the target image itself, the system trains the translation neural network to achieve this effective performance despite not needing any supervised examples of the task being performed, i.e., through unsupervised learning.

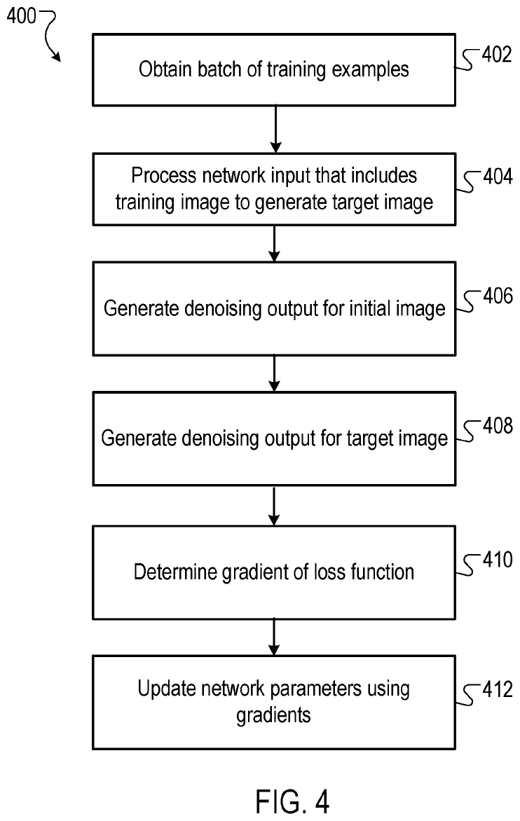

An example of performing a training iteration is described below with reference to FIG. 4.

FIG. 4 is a flow diagram of an example process 400 for performing a training iteration during the training of an image-to-image translation neural network. For convenience, the process 400 will be described as being performed by a system of one or more computers located in one or more locations. For example, a training system, e.g., the neural network system 100 depicted in FIG. 1, appropriately programmed in accordance with this specification, can perform the process 400.

The system obtains, from the training data, a batch of one or more training examples for the training iteration (step 402). When the training data includes training data for multiple tasks, the system can sample a batch of training examples for a particular task, e.g., a randomly selected task, or randomly sample a batch that can include training examples for multiple tasks.

The system then performs steps 404-410 for each of the training examples in the batch.

The system processes a network input that includes the initial image in the training example using the image-to-image translation neural network to generate a target image (step 404).

When the image-to-image translation neural network is a multi-task neural network, i.e., the set of image editing tasks includes multiple tasks, the network input also includes data characterizing the corresponding image editing task to be performed on the initial image.

For example, the data characterizing the corresponding image editing task can be an embedding of the image editing task that is learned during the training of the image-to-image translation neural network.

The system generates a denoising output for the initial image (step 406).

As part of generating the denoising output, the system processes a first diffusion input that includes the initial image in the training example and the text description for the initial image in the training example using the trained diffusion neural network to generate an initial denoising output for the initial image.

As part of processing the first diffusion input, the system can generate a noisy image from the initial image, e.g., by applying sampled noise sampled from a noise distribution in accordance with the noise level for a sampled time step, and then process the noisy image, the text description, and, optionally, the sampled time step using the trained diffusion neural network to generate the initial denoising output.

An example of generating a noisy image is described above.

In some implementations, the denoising output is equal to the initial denoising output.

In some other implementations, the system uses classifier-free guidance to generate the denoising output.

In these implementations, the system processes a third diffusion input that includes the initial image and does not include the text description for the initial image using the trained diffusion neural network to generate an initial unconditioned denoising output for the initial image.

In particular, when processing the third diffusion input, the system processes the noisy image generated from the initial image but not the text description to generate the initial unconditional denoising output.

The system then combines the initial denoising output for the initial image and the initial unconditioned denoising output for the initial image in accordance with a guidance weight for the training iteration to generate the denoising output, e.g., by computing a weighted sum of the initial denoising output for the initial image and the initial unconditioned denoising output.

The system generates a denoising output for the target image (step 408).

As part of generating the denoising output, the system processes a second denoising input that includes the target image and the text description for the target image using the trained diffusion neural network to generate an initial denoising output for the target image.

As part of processing the second diffusion input, the system can generate a noisy image from the target image, e.g., by applying the sampled noise sampled from the noise distribution in accordance with the noise level for the sampled time step, and then process the noisy image, the text description, and, optionally, the sampled time step using the trained diffusion neural network to generate the initial denoising output. That is, the system uses the same sampled noise and the same sampled time step for both the first and second denoising inputs.

An example of generating a noisy image is described above.

In some implementations, the denoising output is equal to the initial denoising output.

In some other implementations, the system uses classifier-free guidance to generate the denoising output.

In these implementations, the system processes a fourth diffusion input that includes the target image and does not include the text description for the target image using the trained diffusion neural network to generate an initial unconditioned denoising output for the target image.

In particular, when processing the fourth diffusion input, the system processes the noisy image generated from the target image but not the text description to generate the initial unconditional denoising output.

The system then combines the initial denoising output for the target image and the initial unconditioned denoising output for the target image in accordance with a guidance weight for the training iteration to generate the denoising output, e.g., by computing a weighted sum of the initial denoising output for target initial image and the initial unconditioned denoising output.

In some implementations, the system uses a fixed guidance weight for all of the training iterations.

In some other implementations, however, the system determines the guidance weight for the training iteration according to a schedule for the guidance weight that is based on a time index of the training iteration within the training. For example, the schedule can increase the guidance weight for training iterations with higher time indices. By gradually increasing the guidance weight, the network gradually learns to make larger changes to the input image with respect to the translation task and avoids local minima.

Additionally, as described above, each diffusion input includes a timestep. To ensure consistency between the diffusion outputs, for each initial image, the timestep is the same in each diffusion input that includes the initial image or the target image generated from the initial image.

The system determines, using the denoising outputs for the initial image and the target image, a gradient of a loss function with respect to the parameters of the image-to-image translation neural network (step 410).

In particular, the system can determine, e.g., through backpropagation, a gradient of the target image with respect to the parameters of the image-to-image translation neural network and then determine the gradient of the loss function using the denoising outputs for the initial image and the target image and the gradient of the target image.

As a particular example, the gradient of the loss function can include a first gradient term that is based on the DDS, i.e., on a difference between the denoising output for the target image and the denoising output for the initial image. As a particular example, the first gradient term can be based on a product of the DDS and the gradient of the target image.

In some implementations, the gradient can also include one or more additional gradient terms.

For example, the gradient of the loss function can include an identity regularization gradient term that measures a gradient with respect to the parameters of the image-to-image translation neural network of a term that measures fidelity between the initial image and the target image.

The identity regularization gradient term can be any appropriate measure of the fidelity between two different images. For example, the term can measure the square L2 distance between the two images, i.e., the mean squared pixel-wise distance between corresponding pixels in the two images.

In this example, the identity regularization gradient term can be weighted by a weight in the gradient of the loss function, e.g., so that the gradient of the loss function is equal to the first gradient minus the product of the weight and the identity regularization gradient term.

In some cases, the weight can be a function of the training iteration and can be higher for earlier training iterations than for later training iterations during the training. For example, the weight can be a function of the training iteration, such that at the beginning of the training, the system injects prior knowledge on the desired output, and gradually reduces it during training with a decay, e.g., a cosine decay.

The system then updates the network parameters of the image-to-image translation neural network using the gradients of the loss function for the one or more initial images (step 412). For example, the system can combine, e.g., average the gradients, to generate a combined gradient and then apply an optimizer to the combined gradient to update the network parameters.

FIG. 5 shows an example 500 of the training of the image-to-image translation neural network 120, denoted as θ in the Figure.

In the example of FIG. 5, the translation neural network 120 is a multi-task neural network that is currently being trained on a training example for an editing task 510 that can be described as “Change it to sunrise.”

The translation neural network receives a network input that includes an initial image \hat{z} 520 and data characterizing the task 510 (e.g., an embedding) and processes the initial image to generate a target image z 530.

The system then computes the gradient with respect to θ of a loss L that is based on the DDS computed based on the initial image, a text description 540 of the initial image “Cliffs at day time” and a text description 550 of the target image “Cliffs at sunrise.”

During inference, i.e., after training, the system can perform the “Change it to sunrise” task 510 on a new, arbitrary input image in a single forward pass, i.e., by processing the input image while being conditioned on the embedding for the task.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
obtaining training data that comprises a plurality of training examples, wherein each training example corresponds to a respective image editing task from a set of one or more image editing tasks and comprises a respective initial image, a respective text description of the respective initial image, and a respective target text description for the initial image that describes a target image that is generated by performing the corresponding image editing task on the respective initial image;
training an image-to-image translation neural network on the training data, wherein the image-to-image translation neural network is configured to receive a network input comprising an input image and to process the network input to generate an output image, and wherein the training comprises, at each of a plurality of training iterations:
obtaining, from the training data, a batch of one or more training examples for the training iteration;
for each of the one or more training examples:
processing a network input comprising the initial image in the training example using the image-to-image translation neural network to generate a target image;
generating a denoising output for the initial image, comprising processing a first diffusion input that comprises the initial image and the text description for the initial image using a trained diffusion neural network to generate an initial denoising output for the initial image;
generating a denoising output for the target image, comprising processing a second denoising input comprising the target image and the text description for the target image using the trained diffusion neural network to generate an initial denoising output for the target image; and
determining, using the denoising outputs for the initial image and the target image, a gradient of a loss function with respect to the parameters of the image-to-image translation neural network; and
updating the network parameters of the image-to-image translation neural network using the gradients of the loss function for the one or more initial images.

2. The method of claim 1, wherein determining, using the denoising outputs for the initial image and the target image, a gradient of a loss function with respect to the parameters of the image-to-image translation neural network comprises:
determining a gradient of the target image with respect to the parameters of the image-to-image translation neural network; and
determining the gradient of the loss function using the denoising outputs for the initial image and the target image and the gradient of the target image.

3. The method of claim 2, wherein the gradient of the loss function comprises a first gradient term that is based on a difference between the denoising output for the target image and the denoising output for the initial image.

4. The method of claim 3 wherein the first term is based on a product between the difference and the gradient of the target image.

5. The method of claim 1, wherein the gradient of the loss function comprises an identity regularization gradient term that measures a gradient with respect to the parameters of the image-to-image translation neural network of a term that measures fidelity between the initial image and the target image.

6. The method of claim 5, wherein the identity regularization gradient term is weighted by a weight in the gradient of the loss function.

7. The method of claim 6, wherein the weight is a function of the training iteration and is higher for earlier training iterations than for later training iterations during the training.

8. The method of claim 1, wherein generating a denoising output for the initial image further comprises:
processing a third diffusion input that comprises the initial image and does not include the text description for the initial image using the trained diffusion neural network to generate an initial unconditioned denoising output for the initial image; and
combining the initial denoising output for the initial image and the initial unconditioned denoising output for the initial image in accordance with a guidance weight for the training iteration to generate the denoising output.

9. The method of claim 8, wherein generating a denoising output for the target image further comprises:
processing a fourth diffusion input that comprises the target image and does not include the text description for the target image using the trained diffusion neural network to generate an initial unconditioned denoising output for the target image; and
combining the initial denoising output for the target image and the initial unconditioned denoising output for the target image in accordance with the guidance weight for the training iteration to generate the denoising output.

10. The method of claim 9, further comprising:
determining the guidance weight for the training iteration according to a schedule for the guidance weight that is based on a time index of the training iteration within the training.

11. The method of claim 10, wherein the schedule increases the guidance weight for training iterations with higher time indices.

12. The method of claim 1, wherein each diffusion input further comprises a timestep and wherein, for each initial image, the timestep is the same in each diffusion input that includes the initial image or the target image generated from the initial image.

13. The method of claim 1, wherein the set of image editing tasks includes only a single task.

14. The method of claim 1, wherein the set of image editing tasks comprises a plurality of image editing tasks and wherein each network input comprises data characterizing the corresponding image editing task for the training example.

15. The method of claim 14, wherein the data characterizing the corresponding image editing task is an embedding of the image editing task and wherein the embedding is learned during the training of the image-to-image translation neural network.

16. The method of claim 1, wherein the trained diffusion neural network is a latent diffusion neural network.

17. The method of claim 16, wherein the image-to-image translation neural network is associated with a pre-trained image encoder that is configured to encode images from a pixel space to the latent space, the image-to-image translation neural network that is configured to process an input image in the latent space to generate a target image in the latent space, and a pre-trained image decoder is configured to decode the target image in the latent space into an output image in the pixel space.

18. The method of claim 16, wherein the initial image in each training examples has been generated by processing an original initial image in a pixel space using an image encoder neural network.

19. A system comprising:
one or more computers; and
one or more storage devices storing instructions that, when executed by the one or more computers, cause the one or more computers to perform operations comprising:
obtaining training data that comprises a plurality of training examples, wherein each training example corresponds to a respective image editing task from a set of one or more image editing tasks and comprises a respective initial image, a respective text description of the respective initial image, and a respective target text description for the initial image that describes a target image that is generated by performing the corresponding image editing task on the respective initial image;
training an image-to-image translation neural network on the training data, wherein the image-to-image translation neural network is configured to receive a network input comprising an input image and to process the network input to generate an output image, and wherein the training comprises, at each of a plurality of training iterations:
obtaining, from the training data, a batch of one or more training examples for the training iteration;
for each of the one or more training examples:
processing a network input comprising the initial image in the training example using the image-to-image translation neural network to generate a target image;
generating a denoising output for the initial image, comprising processing a first diffusion input that comprises the initial image and the text description for the initial image using a trained diffusion neural network to generate an initial denoising output for the initial image;
generating a denoising output for the target image, comprising processing a second denoising input comprising the target image and the text description for the target image using the trained diffusion neural network to generate an initial denoising output for the target image; and
determining, using the denoising outputs for the initial image and the target image, a gradient of a loss function with respect to the parameters of the image-to-image translation neural network; and
updating the network parameters of the image-to-image translation neural network using the gradients of the loss function for the one or more initial images.

20. (canceled)

21. A method performed by one or more computers, the method comprising:
receiving an initial image, a text description of the initial image, and a target text description that describes a target image to be generated by performing an image editing task on the initial image;
generating a denoising output for the initial image, comprising processing a first diffusion input that comprises the initial image and the text description for the initial image using a trained diffusion neural network to generate an initial denoising output for the initial image;
initializing an estimate of the target image;
updating the estimate of the target image at each of a plurality of update iterations, comprising, at each update iteration:
generating a denoising output for the estimate of the image, comprising processing a second denoising input comprising the estimate of the target image and the target text description using the trained diffusion neural network to generate an initial denoising output for the target image; and
determining an update to the estimate of the target image based on the denoising output for the estimate of the target image and the denoising output for the initial image; and
generating the target image from the estimate of the target image after being updated at a last update iteration of the plurality of update iterations.

22. The method of claim 21, wherein initializing an estimate of the target image comprises initializing the estimate to be equal to the initial image.

23. The method of claim 21, wherein the target image is equal to the estimate of the target image after being updated at the last update iteration of the plurality of update iterations.

24. The method of claim 21, wherein the estimate of the target image is a representation in a latent space.

25. The method of claim 24, wherein initializing an estimate of the target image comprises:
processing the initial image using an image encoder neural network to encode the input image into the latent space.

26. The method of claim 24, wherein generating the target image from the estimate of the target image after being updated at a last update iteration of the plurality of update iterations comprises:
processing the estimate of the target image after being updated at a last update iteration of the plurality of update iterations using a decoder neural network to generate the target image.

27. The method of claim 21, wherein determining an update to the estimate of the target image based on the denoising output for the estimate of the target image and the denoising output for the initial image comprises:
determining a difference between the denoising output for the estimate of the target image and the denoising output for the initial image; and
determining the update based on the difference.

28. The method of claim 27, wherein determining the update based on the difference comprises:
determining, from at least the difference, an optimizer input to an optimizer; and
applying the optimizer to the optimizer input to determine the update.

29. The method of claim 21, wherein generating a denoising output for the initial image further comprises:
processing a third diffusion input that comprises the initial image and does not include the text description for the initial image using the trained diffusion neural network to generate an initial unconditioned denoising output for the initial image; and
combining the initial denoising output for the initial image and the initial unconditioned denoising output for the initial image in accordance with a guidance weight for the training iteration to generate the denoising output.

30. The method of claim 29, wherein generating a denoising output for the estimate of the target image further comprises:
processing a fourth diffusion input that comprises the estimate of the target image and does not include the target text description using the trained diffusion neural network to generate an initial unconditioned denoising output for the estimate of the target image; and
combining the initial denoising output for the estimate of the target image and the initial unconditioned denoising output for the estimate target image in accordance with the guidance weight for the training iteration to generate the denoising output.

31. (canceled)

32. (canceled)

33. (canceled)
